(19) United States
(12) Patent Application Publication
(10) Pub. No.: US 2001/0047372 A1
(43) Pub. Date: Nov. 29, 2001

(54) Nested relational data model

(76) Inventors: Alexander Gorelik, Fremont, CA (US); Sachinder S. Chawla, San Francisco, CA (US); Awez I. Syed, Rockville, MD (US); Leon Burda, Cupertino, CA (US); Mon F. Yee, Sunnyvale, CA (US); Sridhar Grantimahapatruni, Sunnyvale, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/782,186

(22) Filed: Feb. 12, 2001

Related U.S. Application Data
(60) Provisional application No. 60/182,047, filed on Feb. 11, 2000.

(51) Int. Cl. G06F 15/00

(52) U.S. Cl. 707/514

(57) ABSTRACT

In a data processing system, hierarchical documents or hierarchical messages are mapped to a Nested Relational Data Model to allow for transformation and manipulation using declarative statements. The resulting nested data can be converted to a relational format and mapped to multiple relational tables, and/or converted from a nested relational format to an external hierarchical format, such as XML. The system can specify and execute declarative rules to extract, transform, integrate, load and update hierarchical and relational data. The system can also be used for extending documents with relational and non-relational data and applying updates based on these documents to relational database targets. The system can also be used for mapping Nested Relational Data to function calls that accept tables as parameters and return multiple scalar and table parameters as output.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates to information management in general and more particularly to methods for using Nested Relational Data Models (NRDMs) to manage information.

### BACKGROUND OF THE INVENTION

Information is commonly managed in units of documents. For example, sales, distribution and manufacturing information might be contained within documents such as sales invoices or orders. Increasingly, documents pass between parties in electronic form, in a process generally referred to as EDI (Electronic Data Interchange). In electronic form, the documents are not limited to the text and images shown on the printed page, but can include formatting and “metadata” (data about the data). One example of a format for an electronic document that contains metadata is the Extended Markup Language (XML).

Several products on the market allow mapping of XML documents to SQL tables or vice versa and several products on the market allow mapping of EDI documents to relational tables or vice versa, but these products typically require procedural specifications of how to perform the conversion, such as programming code. Traditional Relational Database Management Systems (RDMS's) such as described by Date or Ullman or implemented by Oracle, IBM, Microsoft and others as well as distributed databases as described in Ceri or U.S. Pat. Nos. 5,884,310 and 5,596,744, implement declarative transformations of relational data.

A class of systems called intelligent gateways (such as Sybase's OmniServer system) allow declarative rules to be transparently applied to heterogeneous relational databases. Another class of systems called Replication Servers (such as described by U.S. Pat. No. 5,737,601 or implemented as Sybase's Replication Server, Oracle's Replication Server, or the like) can provide homogeneous or heterogeneous data replication.

Additional class of systems called the ETL (Extraction, Transformation, Loading) systems such as Microsoft DTS, Informatica PowerMart and D2K Tapestry provide extraction, transformation and loading of heterogeneous data between relational database systems. Some of these products support converting hierarchical files into a relational form by “flattening” the hierarchical files, making multiple passes through a hierarchical file and, at each pass, pulling out different parts of the hierarchy.

Yet another class of systems that address mapping of relational data to a programming object, as exemplified by U.S. Pat. Nos. 6,175,837, 6,163,781, 6,134,559, 5,907,846, 5,873,093, 5,832,498, or products from Persistence, Bea and others. This class of tools maps persistently stored relational data to an object-oriented memory representation as well as mapping the data from an object-oriented memory representation to a set of persistent relational tables.

Another class of prior art exists that provides object-oriented access to non-relational databases, as described in U.S. Pat. Nos. 5,799,313, 5,778,379, and 5,542,078. This class of systems addresses the mapping of data from hierarchical databases such as IMS, object oriented databases and relational databases to an object-oriented programming object or database.

Considerable research has been done on Nested Relational Data Models as described in______, “Lecture Notes in Computer Science Volume 595: M. Levene—The Nested Universal Relation Database Model” and______, “Lecture Notes in Computer Science Volume 361: S. Abiteboul et al.—Nested Relations and Complex Objects in Databases”. That research focused mainly on defining the data model and specific operations on it.

It is known to graphically map disparate schemas to each other. See, for example, U.S. Pat. Nos. 5,850,631 and 5,806,066. It is also known to map data between different structures. See for example, U.S. Pat. Nos. 5,627,972 and 5,119,465.

### SUMMARY OF THE INVENTION

In one embodiment of data processing system according to the present invention, hierarchical documents or hierarchical messages are mapped to a Nested Relational Data Model to allow for transformation and manipulation using declarative statements. The resulting nested data can be converted to a relational format and mapped to multiple relational tables, and/or converted from a nested relational format to an external hierarchical format, such as XML.

The system can specify and execute declarative rules to extract, transform, integrate, load and update hierarchical and relational data. The system can also be used for extending documents with relational and non-relational data and applying updates based on these documents to relational database targets. The system can also be used for mapping Nested Relational Data to function calls that accept tables as parameters and return multiple scalar and table parameters as output.

### BRIEF DESCRIPTION OF THE DRAWINGS

FIG. 1 shows a table that is related to a single row of another table.

FIG. 2 shows the data of FIG. 1, organized as multiple rows in a single table.

FIG. 3 shows the data of FIG. 1, organized as multiple tables related by a join.

FIG. 4 illustrates multiple levels of nested tables contained in one column.

FIG. 5 illustrates a more general example of multiple levels of nested tables contained in more than one column.

FIG. 6 is a block diagram of a database system according to one embodiment of the present invention.

FIG. 7 illustrates schema relating to nested tables; FIG. 7A shows input tables and FIG. 7B shows an output schema.

FIG. 8 illustrates a process of grouping values across nested tables.

FIG. 9 illustrates a process of unnesting data; FIG. 9A shows how a table with a nested table would be unnested into a cross-product of the parent table and a child (nested) table; FIG. 9B illustrates unnesting into separate tables; FIG. 9C illustrates unnesting at multiple levels.

FIG. 10 illustrates a case where unnesting might produce unintended effects.

FIG. 11 graphically illustrates an unnesting process and its effects on a query.

FIG. 12 illustrates a process of converting a DTD to tables.

FIG. 13 illustrates the XML encoding of a DTD definition.

FIG. 14 illustrates various real-time data flows.

FIG. 15 illustrates an operation of joining two inputs in a query.

FIG. 16 illustrates real-time data flows that use supplementary information.

FIG. 17 illustrates data flows depending on cached values.

FIG. 18 illustrates branching data flows based on rules.

FIG. 19 is an illustration of a complex real-time data flow.

FIG. 20 is an illustration of a GUI for specifying a data flow.

FIG. 21 is a block diagram of a schema conversion system.

FIGS. 22-26 are tables illustrating various aspects of an NRDM system.

### DESCRIPTION OF THE SPECIFIC EMBODIMENTS

In a specific embodiment a Nested Relational Data Model (NRDM) is designed to support hierarchical and relational components used to represent business data. Business documents are typically hierarchical with multiple repeating sets. For example, an order contains a set of repeating line items. It may also have a set of customers associated with it.

Business documents used to exchange data between software systems within an enterprise or between enterprises need to be represented as complex hierarchical documents. The industry and the research community use well-known representations such as EDI and XML to capture and represent such documents. The system described herein provides methods for mapping such documents to a Nested Relational format, methods for transforming and manipulating of these documents represented using the Nested Relational Data Model, converting such documents to relational format and mapping them to multiple relational tables, and a method of converting the data in a nested relational format back to an external hierarchical format such as XML.

The system provides a method to apply declarative rules to map the hierarchical (e.g., XML or EDI) data to relational tables and vice versa; declarative rules to enrich hierarchical data with data from other relational or hierarchical sources; declarative rules to perform multi-stage transformations. The system allows declarative transformations to be applied to hierarchical data, and the ability to transparently apply rules to heterogeneous databases and files; as well as in the ability to apply multi-stage transformations. Delcarative specifications (such as SQL) describe what to do with data, as opposed to procedural specifications (such as C++ code) that described how to do it.

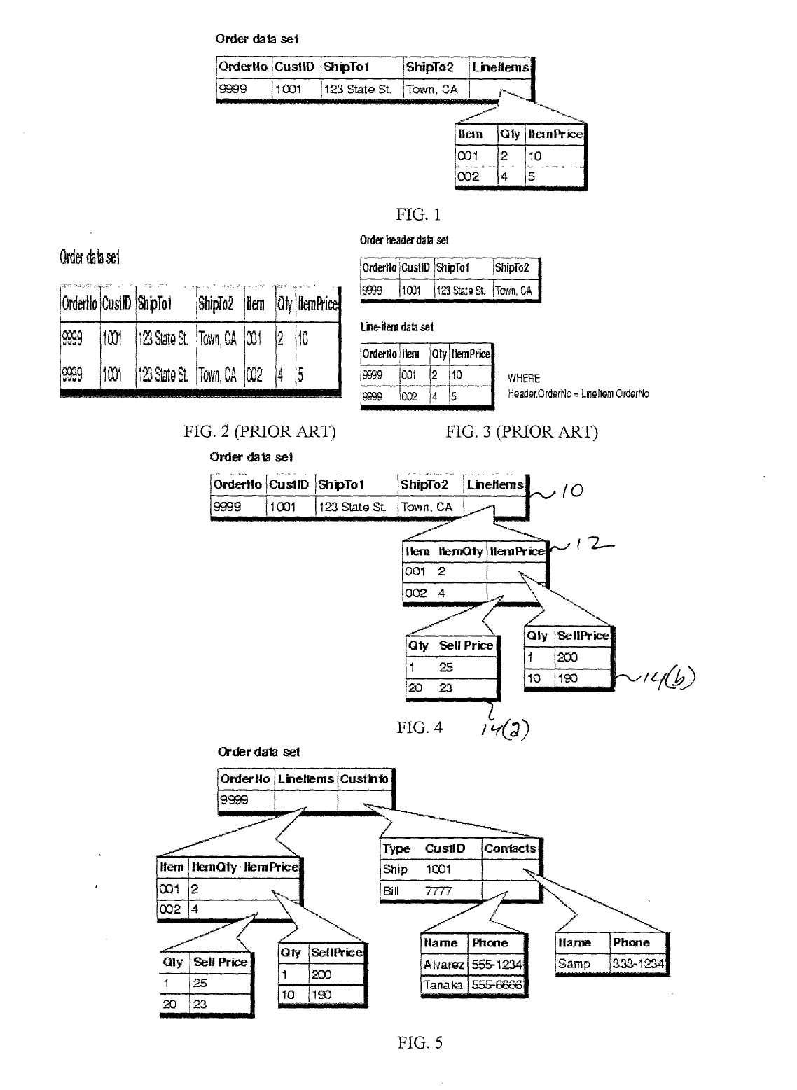

“Nested data” is data in a table that is related to a single row of another table. Sales orders are often presented using nesting: the line items in a sales order are related to a single header. For a table of sales order headers, each row includes its own table of line items. An example of this is shown in FIG. 1. Of course, the same data could be represented without nested tables. For example, the data could be represented as multiple rows in a single table as shown in FIG. 2, or as multiple tables related by a join as shown in FIG. 3.

One source of data for a nested table is the result of a query using the values in the related row in the parent table. As used herein, “parent table” refers to a table within which another table is nested and “child table” or “nested table” refers to a table that is nested in a column of a parent table. A nested table is said to have a relationship with the table within which it is nested and where levels are associated with tables, a parent table would have a level that is designated with a number one higher than the child tables nested in that parent table. For example, FIG. 4 shows a parent table 10, a nested (child) table 12 one level below table 10 and nested tables 14(a)-(b) that are nested in table 12 and are two levels below table 10.

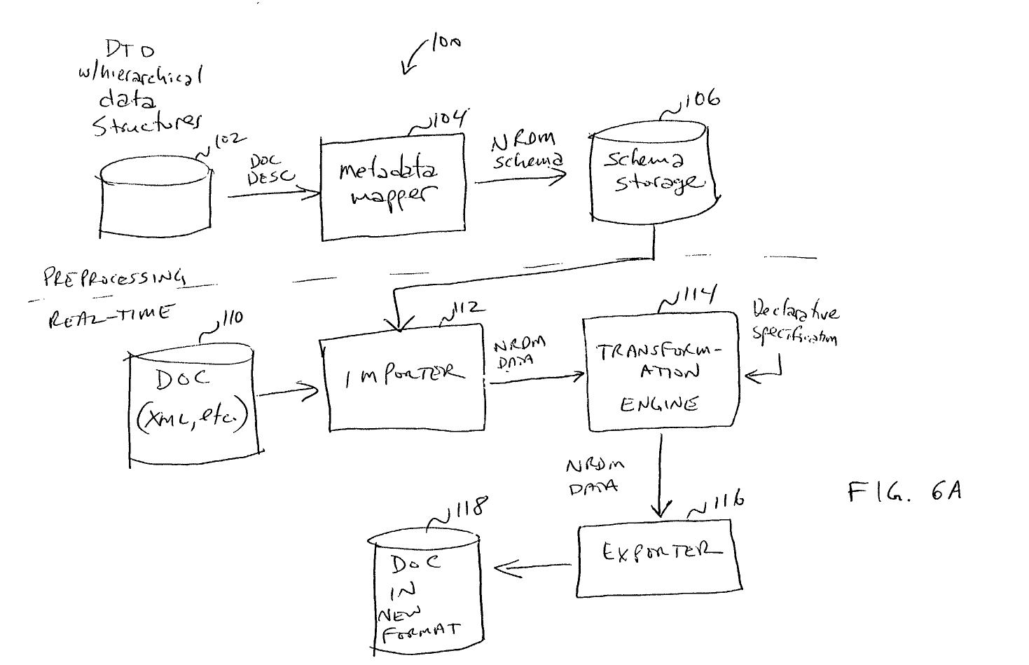

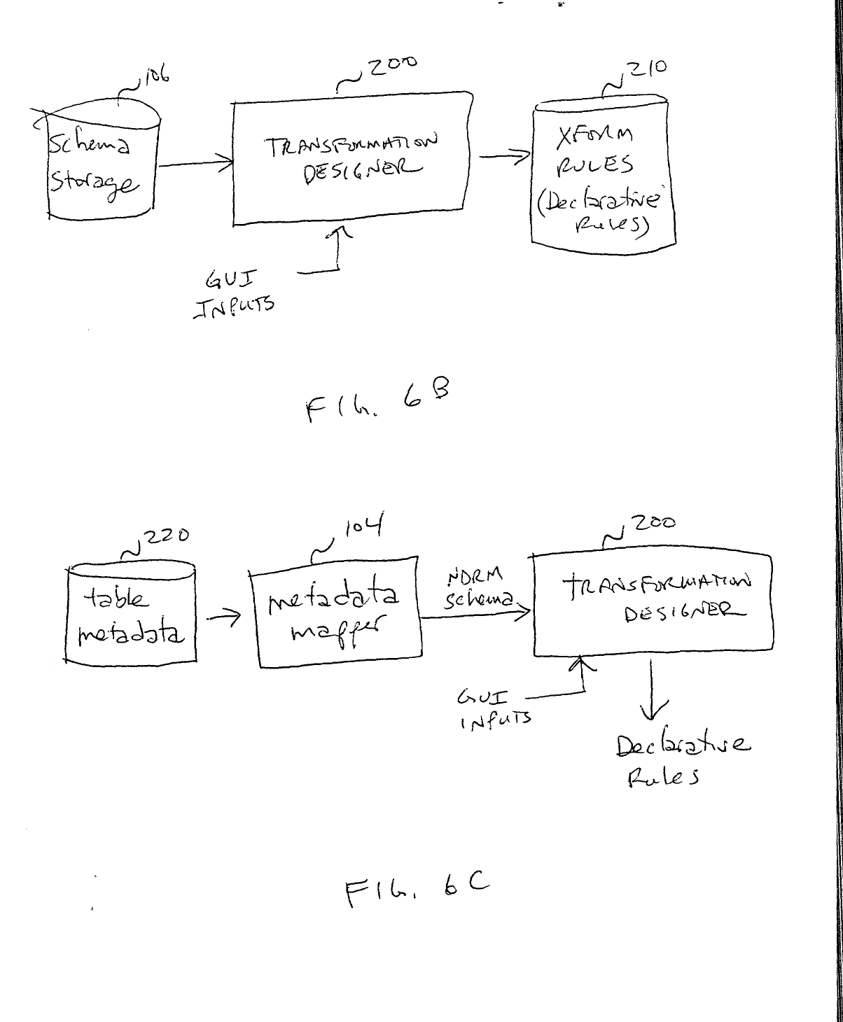

Preferably, a unique instance of each nested table exists for each row at each level of a relationship. As illustrated in FIG. 5, each row at each level can have any number of columns containing nested tables.

FIG. 6 shows various aspects of a database system 100 that handles NRDM data. System 100 is shown comprising a metadata mapper 104 that maps DTD 102 w/hierarchical structures to NRDM schema that are stored in schema storage 106. These components are shown as being part of a preprocessing section, with other portions being part of a real-time section, but it should be understood that all of the process or none of the processing might be done in real-time without departing from the essence of the invention. Notwithstanding that caveat, the descriptions below reference an example wherein DTDs are converted to NRDM schema and stored and documents are converted by system 100 in real-time after such conversion.

One such real-time process involved a document 110 being passed to an importer, then to a transformation engine (TE) 114 and an exporter 116 to result in a document in a new format 118 (in some cases, the formats of document 110 and document 118 might be the same, but some transformation has occurred). Document 110 is a structured document, such as an XML document, an HTML page, a document having other structure, or other structured data object.

Importer 112 converts the document into NRDM data so that TE 114 can operate on data in the NRDM space, thus simplifying many transform operations, as described below. TE 114 accepts data in NRDM format as its input and outputs data in NRDM format. Of course, data in NRDM (Nested Relational Data Model) format need not have nested data (for example, if the input data can be structured such that nesting is not needed). Because TE 114 operates on NRDM structures, the transformations performed by TE 114 can be expressed simply as a declarative specification, thus greatly simplifying the process of transforming complex data. In effect, importer 112 converts a hierarchical document into a relational database form to which declarative statements can be applied.

Exporter 116 exports the data in a suitable form, such as XML documents, relational tables or flat files.

Data Flows

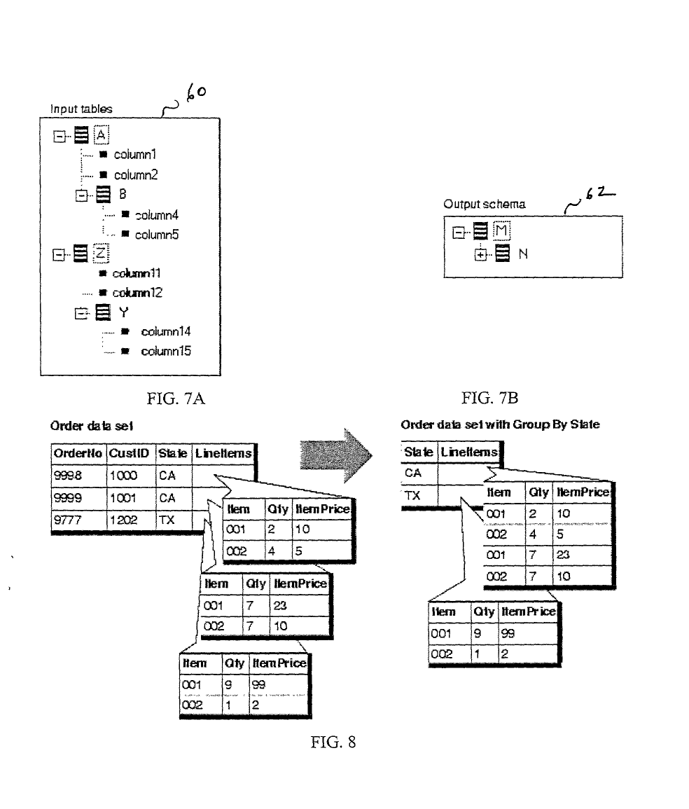

In a graphical interface used to build data flows and/or nested data structures, such as the ActaWorks™ system developed by Acta, Inc. structures of nested data in input and output schemas of sources, targets, and transforms in data flows are presented to a designer. An example of an input schema 60 is shown in FIG. 7A and an example of an output schema 62 is shown in FIG. 7B. Input schema 60 shows a table A that has columns columnm1, column2 and a column for a nested table B, which in turn has columns column4 and column5. Input schema 60 also shows a table Z that has columns column11, column12 and a column for a nested table Y, which in turn has columns column14 and column15. In FIG. 7A, and others, nested tables appear with a table icon paired with a plus sign, which indicates that the object contains columns (a minus sign indicates that the object is open and if it has columns, those columns are visible.

In a relational database system (RDS) using a declarative language such as SQL, a query transform might take the form of a SELECT statement that is executed by the RDS. When working with nested data in an nested relational data model (NRDM) system according to some aspects of the present invention, the query can specify SELECTs at each level of a relationship defined in the output schema. Thus, while a SELECT statement might be constrained to include only references to relational data sets, a query that includes nested data might include a SELECT statement to define operations on each table in the output—each context for the input data set is transformed.

In such an NRDM system, the FROM clause descriptions and the behavior of the query are the same with nested data as with relational data, but the new interface of contexts allows the data flow designer to distinguish multiple SELECTs from each other within a single query. At any context, the FROM clause can contain any top-level table from the input or any table that is a column of a table in the FROM clause of the next higher context.

When rows of one table (a child table) are nested inside another table (a parent table), the data set produced in the nested table is the result of a query against the first table using the related values from the second table. For example, if sales information is available as a header table and a line-item table, the sales information can be organized as a parent table of header information and a child table containing line-item data here the line-items are nested under the header table. The line items for a single row of the header table are equal to the results of a query including the order number, as might be found using the following statement:

SELECT * FROM LineItems

WHERE Header.OrderNo=eLineItems.OrderNo

Correlation can be used to construct a nested table from columns from a higher-level context. In a nested-relational model, the columns in a nested table are implicitly related to the columns in the parent row. To take advantage of this relationship, the parent table can be used in the construction of the nested table. The higher-level column is a correlated column. Including a correlated column in a nested table may serve at least two purposes: 1) the correlated column is a key in the parent table and 2) making the correlated column an attribute in the parent table. Including the key in the nested table allows for the maintenance of you a relationship between the two tables after converting them from the nested data model to a relational model. Including the attribute in the nested table allows for the use of the attribute to simplify correlated queries against the nested data.

Correlated columns can include columns from the parent table and any other tables in the FROM clause of the parent table. If the correlated column comes from a table other than the immediate parent, the data in the nested table includes only the rows that match both the related values in the current row of the parent table and the value of the correlated column.

Values can be grouped across nested tables. Thus, when a statement includes a Group By clause for a table with a nested table, the grouping operation combines the nested tables for each group. For example, to assemble all the line items included in all the orders for each state from a set of orders, the designer would set the Group By clause in the top-level of the data set to the state column (Order.State) and create an output table that includes State column (set to Order. State) and LineItems nested table. The result of such an operation might result with the table shown in FIG. 8. The result is a set of rows (one for each state) that has the State column and the LineItems nested table that contains all the LineItems for all the orders for that state.

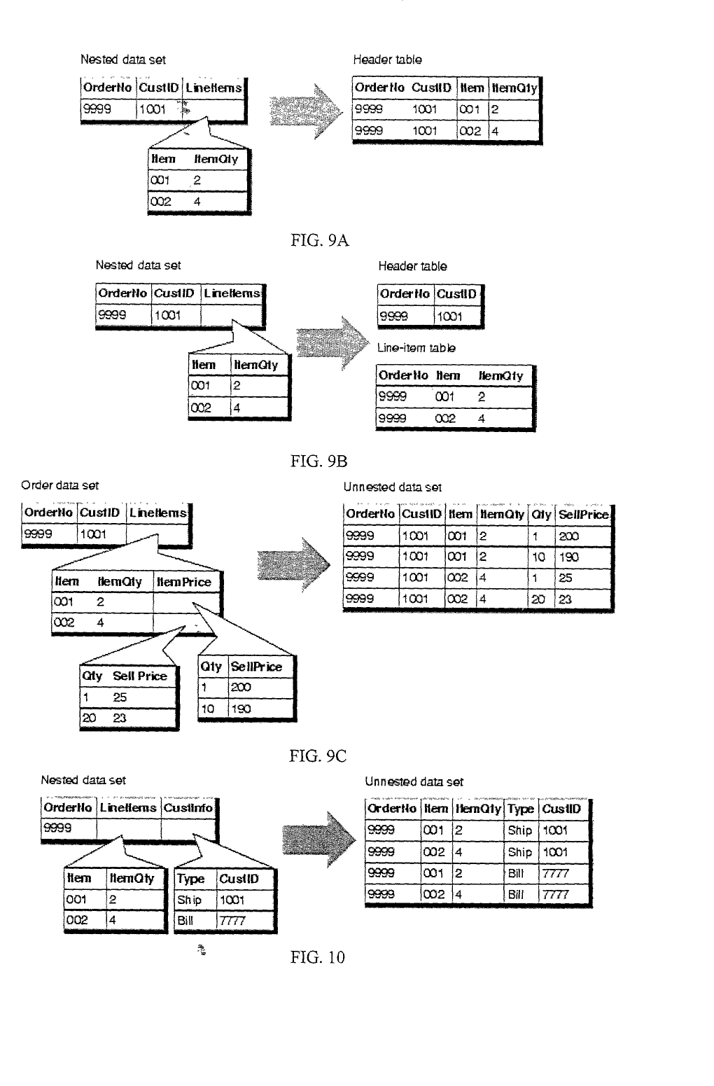

Nested data can also be unnested. When loading a data set that contains nested tables into a relational (non-nested) target, the nested rows will be unnested. Take, for example, a message containing a sales order that uses a nested table to define the relationship between the order header and the order line items. To load the data into relational tables, the multi-level must be unnested. Unnesting a table produces a cross-product of the top-level table (parent) and the nested table (child), as shown in FIG. 9A. Different columns from different nesting levels might be loaded into different tables. A sales order, for example, may be flattened so that the order number is maintained separately with each line item and the header and line item information loaded into separate tables, as shown in FIG. 9B.

Any number of nested tables can be unnested at any depth. No matter how many levels are involved, the result of unnesting tables is a cross product of the parent and child tables. When more than one level of unnesting occurs, the inner-most child is unnested first, then the result—the cross product of the parent and the inner-most child—is then unnested from its parent, and so on to the top-level table, creating the result shown in FIG. 9C.

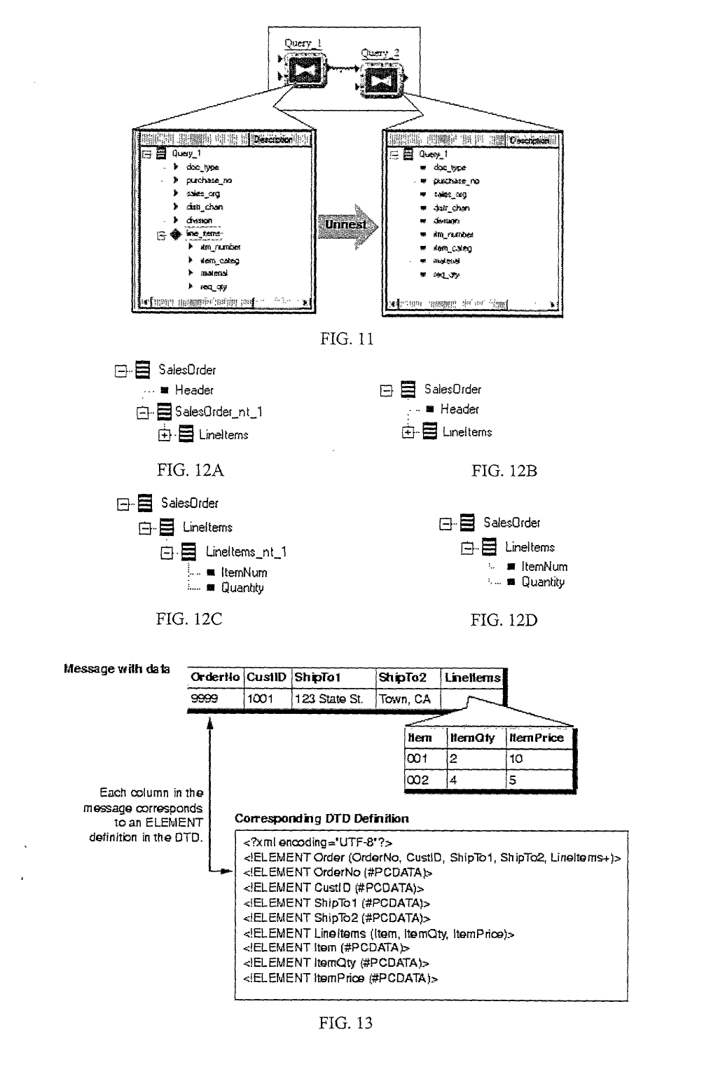

Unnesting all tables (cross product of all data) may not produce the results intended. For example, if multiple customer values are included in an order, such as sbip-to and bill-to addresses, flattening a sales order by unnesting customer and line item tables produces rows of data that may not be useful for processing the order. This is illustrated in FIG. 10. Using the GUI, the specification of the data flow is shown in FIG. 11.

A DTD (document type definition) describes the data schema of an XML message or file. Real-time data flows read and write XML messages based on a specified DTD format. One DTD can describe multiple XML sources or targets. Batch data flows can read and write data to files based on a specified DTD format.

DTDs can be imported into the NRDM system, either directly or by importing an XML document that contains a DTD. During import, the NRDM system converts the structure defined in the DTD into an internal nested-relational data model. Elements below the root-level that contain other elements become nested tables and elements that do not contain other elements become columns. Attributes become columns in the corresponding element's schema.

The NRDM system applies the following rules to convert the DTD to tables, columns, and nested tables:

Any element that contains PCDATA only and no attributes becomes a column.

Any element with attributes or other elements (or in mixed format) becomes a table.

An attribute becomes a column in the table corresponding to the element it supports.

Any occurrence of choice operators is converted to strict ordering.

Any occurrence of optional operators is converted to strict ordering.

Any occurrence of ( )* or ( )⁺ becomes a table with an internally generated name—an implicit table.

After these rules have been applied, the NRDM system optimizes the format using two more rules, except where doing so would allow more than one row at the root element:

If an implicit table contains one and only one nested table, then the implicit table can be eliminated and the nested table can be attached directly to the parent of the implicit table. For example, the SalesOrder element might be defined as follows in the DTD:

<!ELEMENT Salesorder (Header, LineItems*)>

When converted, the LineItems element with the zero or more operator would become an implicit table under the SalesOrder table. The LineItems element itself would be a nested table under the implicit table, as shown in FIG. 12A. Because the implicit table contains one and only one nested table, the format would be optimized to remove the implicit table, as shown in FIG. 12B.

If a nested table contains one and only one implicit table, then the implicit table can be eliminated and its columns placed directly under the nested table. For example, the nested table LineItems might be defined as follows in the DTD:

<!ELEMENT LineItems (ItemNum, Quantity)*>

When converted, the grouping with the zero or more operator would become an implicit table under the LineItems table. The ItemNum and Quantity elements would become columns under the implicit table, as shown in FIG. 12C. Because the LineItems nested table contained one and only one implicit table, it would be optimized to remove the implicit table, as shown in FIG. 12D.

If the DTD contains an element that uses an ancestor element in its definition, the definition of the ancestor can be expanded for a fixed number of levels. For example, given the following definition of element “A”:

A: B, C

B: E, F

F: A, H

The system produces a table for the element “F” that includes an expansion of “A.” In this second expansion of “A,” “F” appears again, and so on until the fixed number of levels. In the final expansion of “A,” the element “F” appears with only the element “H” in its definition.

Real-Time Sources

A real-time source in a real-time data flow determines the message that the real-time data flow will process. The source object represents the schema of the expected messages. Messages received are fit to the schema. Real-time data flows accept real-time source types such as Extensible Markup Language formatted (XML) messages or intermediate documents, such as IDocs published from an SAP R/3 application server.

The format of the XML message is specified by a document type definition (DTD). The DTD describes the schema of data contained in the message and the relationships among the elements in the data. For a message that contains information to place a sales order—order header, customer, and line items—the corresponding DTD includes the order structure and the relationship between data, as shown by the example in FIG. 13.

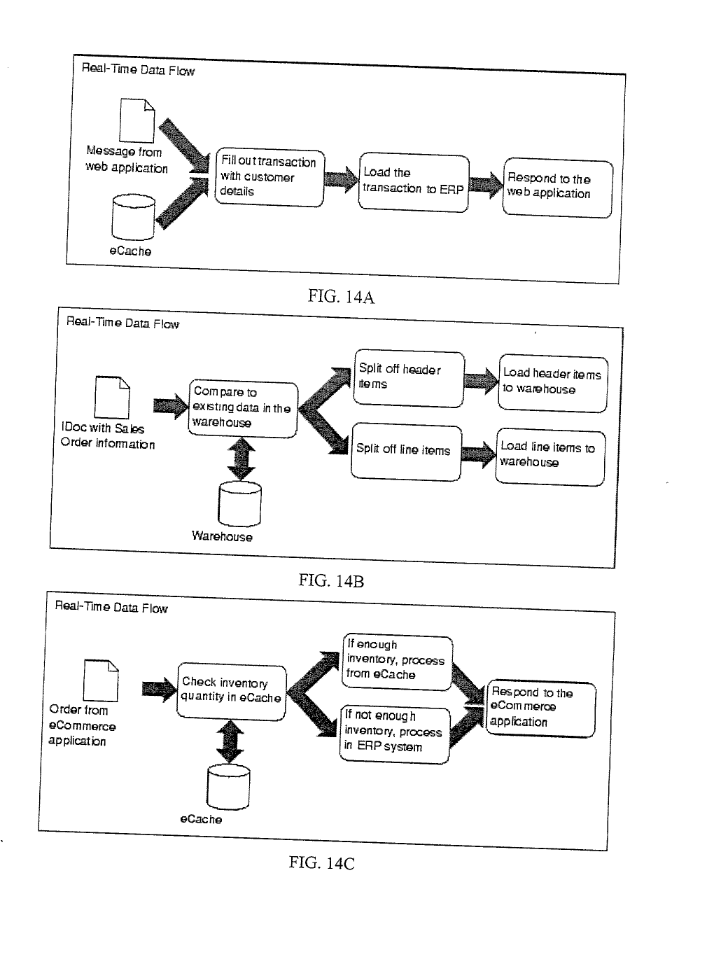

The following examples provide a high-level description of how real-time data flows address typical real-time scenarios. FIG. 14A shows a real-time data flow as might be used to load transactions into an ERP system, such as SAP R/3. A real-time data flow can receive a transaction from an electronic commerce application and load it to an ERP system. Using a query transform, one can include values from a data warehouse to supplement the transaction before applying it against the ERP system.

FIG. 14B shows a real-time data flow for collecting ERP data into a warehouse. Real-time data flows can receive messages from the ERP through IDocs. Each IDoc contains a transaction that the real-time data flow can load into a data warehouse or a data mart. In this way, IDocs can be used to keep the data in a warehouse current.

FIG. 14C shows a real-time data flow for retrieving values from a cache or and ERP system. This allows for real-time data flows that use values from a data warehouse to determine whether or not to query the ERP system directly.

Supplementary Sources

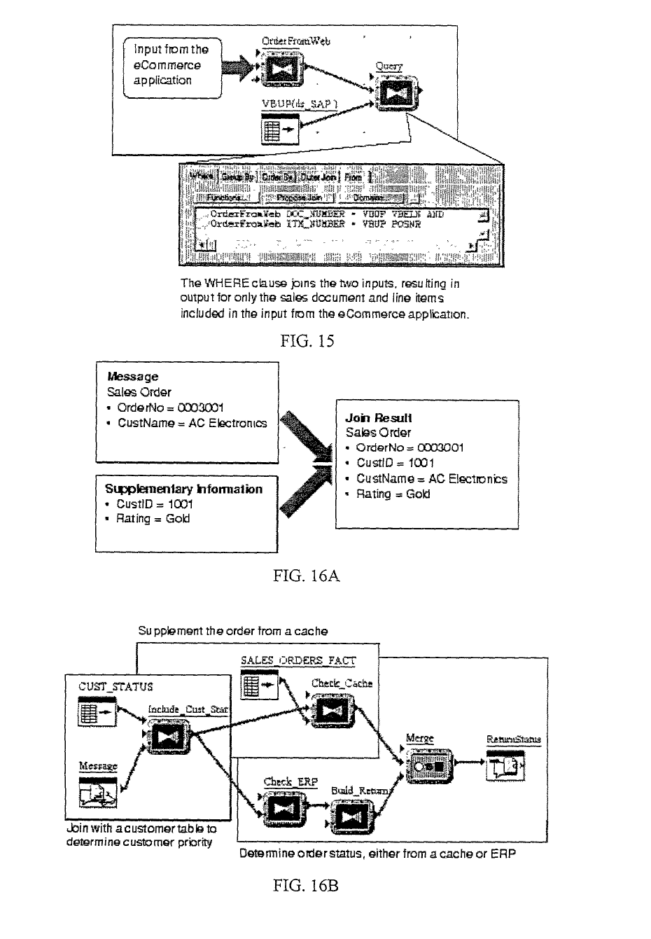

When more data is needed than what is provided in the content of a message to complete the message processing, supplementary sources might be used. For example, processing a message that contains a sales order from an electronic commerce application that contains the customer name might require that, when the order is applied against your ERP system, more detailed customer information is needed. Inside the real-time data flow, the message is supplemented with the customer information to produce the complete document to send to the ERP system. The supplementary information may come from the ERP system itself or from a cache containing the same information cached. Examples of such data flows are shown in FIGS. 15, 16A, 16B.

Tables and files (including XML files) as sources in real-time data flows can provide this supplementary information. The real-time data flow extracts data from the supplementary source as indicated by the logic defined in the real-time data flow.

Tables or files that are used as sources and have a cache option allow for the data extracted to be stored in memory until the data flow processing is complete. In real-time data flows, sources should not be cached unless the data being cached is small and is unlikely to be updated in the life of the real-time data flow.

In batch data flows, caching can improve the performance of data flow processing by reducing the number of times a set of data is read from the database or file source. In real-time data flows, however, the improvement in performance provided by caching is minimized by the likelihood that the real-time data flow reads only a small amount of data from the source for any given message. In addition, because the real-time data flow reloads cached data only when an access server shuts it down and restarts it, cached data may become stale in memory.

Tables can be sources in real-time data flows after their metadata is imported into the repository. When the real-time data flow starts, it opens a connection to the source database. This connection remains open as long as the real-time data flow is running. If a table is included in a join with a real-time source, the data set from the real-time source is included as the outer loop of the join.

R/3 tables can be sources in real-time data flows after their metadata is imported into the repository. When the real-time data flow performs a query against the RW3 table, it executes an R/3 function call to extract the data through the SAP R/3 application server. This method of extracting data from SAP R/3 is particularly well suited to extracting a small amount of specific data (on the order of 1 to 10 rows) in a real-time system, but might not work well as a substitute to using R/3 data flows to produce ABAP programs to extract large amounts of data in a batch system.

Data from XML files can be used as sources in real-time data flows, if a DTD that describes the data in the file is imported.

Supplementing Message Data

The data included in messages from real-time sources may not map exactly to requirements for processing or storing the information. If not, steps can be defined in the real-time data flow to supplement the message information. One technique for supplementing the data in a real-time source includes these steps in a real-time data flow:

1. Include a table or file as a source. In addition to the real-time source, include the files or tables that supply the supplementary information.

2. Use a query to extract needed data from the table or file. Use the data in the real-time source to find the needed supplementary data. A join expression can be used in the query so that only the specific values required from the supplementary source are extracted.

FIG. 16A shows an example where a message includes sales order information with the ultimate goal to return order status. In this case, the business logic uses the customer number and priority rating to determine the level of status to return. The message includes only the customer name and the order number. The real-time data flow is then defined to retrieve the customer number and rating from other sources before determining the order status.

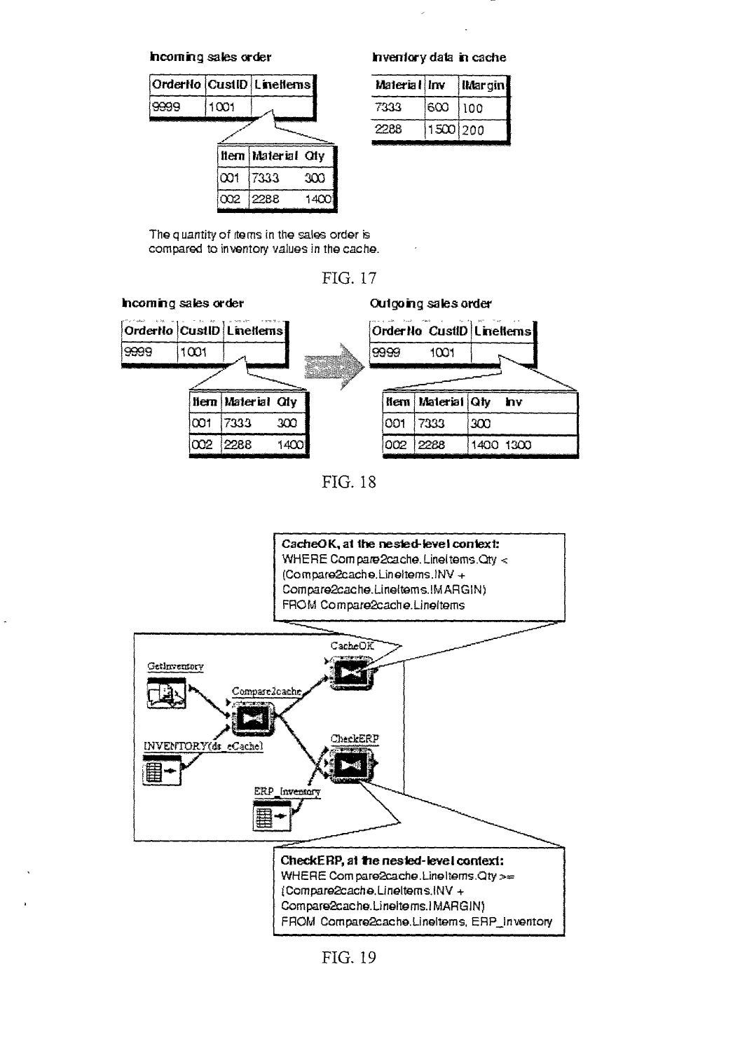

A real-time data flow might include logic to determine when responses can be generated from data in a cache and when they must be generated from data in an ERP system. One technique for constructing this logic includes the steps in the real-time data flow (illustrated in FIGS. 17-20):

1. Determine the rule for when to access the cache and when to access the ERP system.

2. Compare data from the real-time source with the rule.

3. Define each path that could result from the outcome. Consider the case where the rule indicates ERP access, but the ERP system is not currently available.

4. Merge the results from each path into a single data set.

5. Route the single result to the real-time target.

This example describes a section of a real-time data flow that processes a new sales order. The section is responsible for checking the inventory available of the ordered products—it finds an answer to the question, “is there enough inventory on hand to fill this order?” The rule controlling access to the ERP system indicates that the inventory (Inv) must be more than a pre-determined value (IMargin) greater than the ordered quantity (Qty) to consider the cached inventory value acceptable. The comparison is made for each line item in the order.

FIG. 18 illustrates a branch in the data flow based on a rule. An XML source contains the entire sales order, yet the data flow compares values for line items inside the sales order. The XML target that ultimately returns a response requires a single row at the top-most level. Because this data flow needs to be able to determine inventory values for multiple line items, the structure of the output requires the inventory information to be nested. The input is already nested under the sales order; the output can use the same convention. In addition, the output needs to include some way to indicate that the inventory is or is not available.

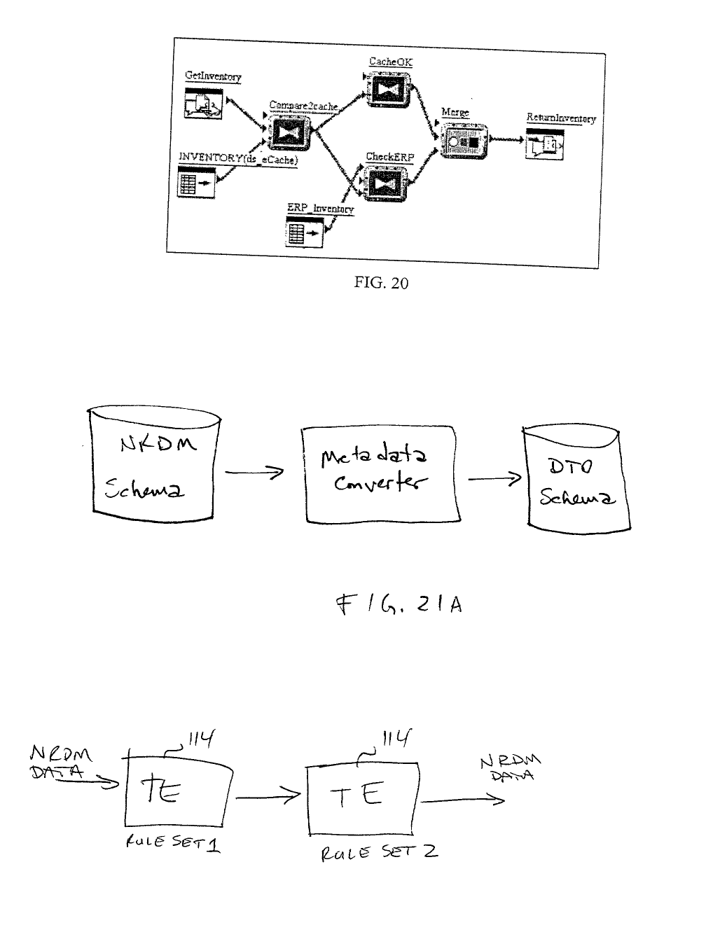

FIG. 19 illustrates several ways to return values from the ERP. For example, a lookup function or a join on the specific table could be used in the ERP system. The example uses a join so that the processing can be performed by the ERP system rather than the NRDM system. As in the previous join, if a value might not be returned by the join, an outer join can be defined so that the line item row is not lost.

FIG. 20 illustrates a GUI used to specify transformations and a specific transformation specified with that GUI.

FIG. 21 is a block diagram of a schema converter. In the example shown, an NRDM schema is converted to a DTD schema.

Other Uses

One of the advantages of operating a transformation engine on NRDM data structures, as described above, is that the transformation engine can operate on hierarchical data as if it were a relational table. Thus, hierarchical documents, such as XML documents can be operated on using declarative statements, such as SQL, regardless of how many levels of hierarchy are present. One method of effecting such a benefit is to nest child tables into columns of parent tables and use a transformation engine that handles NRDM data as its input and as its output. The transformation engine can be sandwiched between an importer that converts hierarchical documents into NRDM data structures and an exporter that generates hierarchical documents from NRDM data structures.

There are various ways to implement NRDM data structures. For example, conventional relational tables can be used, where a column of the parent table stores a pointer to a child table. A separate child table could exist for each row of the parent table that does not have a NULL value for that row and column, or where the child tables for each row have corresponding formats, the data representing the child tables could be implemented as subtables of one child data-holding table. Regardless of the underlying structure, the transformation engine deals with the data structures as nested tables and applies declarative statements accordingly.

Other aspects of the system described herein might find uses apart from NRDM data structures and systems. For example, requests received from applications for data processing and/or transformation might operate on nested tables, but might also operate on conventional relational tables.

The applications often provide application programming interfaces (APIs) through with other programs interact with the application. Often, the designer of a program that interacts with the application must know the interfaces and correctly specify the parameters of a particular function call. However, some applications might accept as an input NRDM data or a hierarchical document. In some cases, the application interface could be such that the semantics of the function call are in a document submitted as a parameter and then one generic interface is all that is needed to call the application.

Example Implementation

An example of an NRDM system according to various aspects of the present invention will now be described. It should be understood that the invention is not limited to this specific example. The example system supports hierarchical data models such as IDoc and XML and provides for a hierarchical structure to support a hierarchical data model represented as a single row that contains scalar columns and repeating group(s) of embedded rows forming nested table(s), where nesting can be arbitrarily deep and an implicit relationship is not required between embedded rows and parent (i.e., the children rows do not need to contain a key to join it back to the parent row).

The NRDM system can capture an entire business transaction in a single hierarchical structure and transform a hierarchical structure as a single entity using relation operators that can be applied at any level of the hierarchy. A hierarchical structure when applied as a single database transaction can be loaded to a set of tables belonging to a single datastore.

Data Model

In NRDM, the first normal form requirement that a column be a scalar is removed. In NRDM, a column can be a scalar or a relation value, which we refer to as a nested table. A scalar column definition has a name, type (including length, precision, domain info, etc.) and, at run time, contains either a value or a NULL indicator. A nested table definition has a name, schema (e.g., a list of column definitions) and, at run time, contains either one or more rows of the schema specified in the nested table definition or an empty table indicator (e.g., ISEMPTY).

DDL Operations

AL_NESTED_TABLE is used below to define a nested table for DDL operations. For example, creating a view with nested table might be done by the following statements:

CREATE VIEW V1 (

ORDER_ID INT,
PROD_INFO AL_NESTED_TABLE(

PROD_ID INT,
QTY INT,
VENDOR_INFO AL_NESTED_TABLE(VNDR_ID CHAR(5),

VNDR_CITY CHAR(65))

),

CID INT,
CCITY CHAR(65)
);

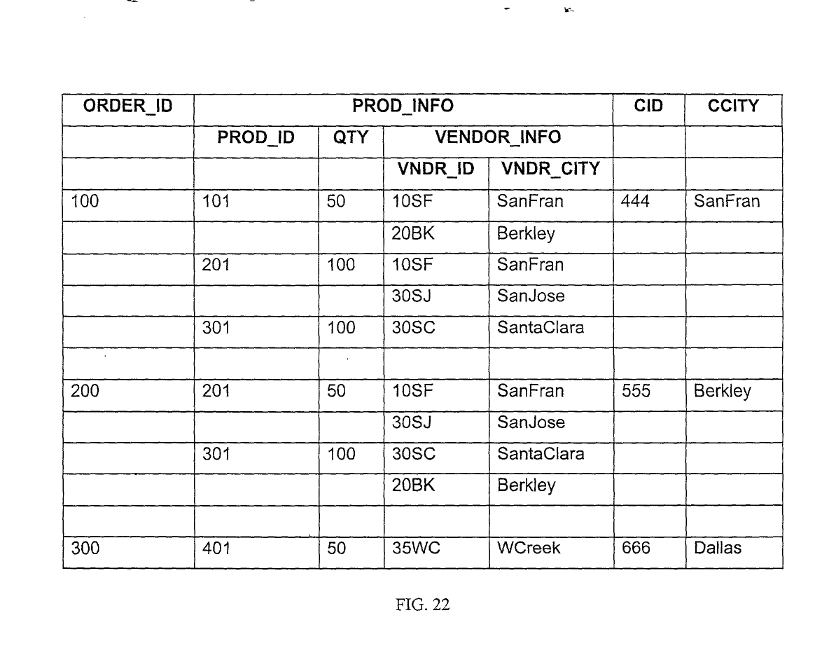

FIG. 22 illustrates a data table that might result for the above statements.

DML Operations

Relational operations such as select, project, etc. can be used on NRDM data. Nested relations can be accessed as regular relations in the context (scope) of their parents. In other words, wherever a scalar column is used, a nested table can be used. If a parent table is used in a FROM clause, all the nested tables can be used in the SELECT and WHERE clauses and nested subqueries as full-fledged tables. If two parent tables having a same name for a nested table are used in a relational operation, the nested tables should be qualified with the parent tables.

Nested subqueries allow for accessing and transforming data inside nested relations. Nested subqueries can transform data in nested relations, nest, unnest and join data in nested relations with the data in its parents and handle operations such as ISEMPTY, AL_NEST, AL_NEST_SET and AL_UNNEST for NRDM data. The AL_NEST operator creates partitions based on the formation of equivalence classes to generate nested tables. It operates on a row basis. AL_NEST_SET operator is similar to AL_NEST but operates on a set basis. The AL_UNNEST operator transforms a relation into one, which is less deeply nested by concatenating each tuple in the relation being unnested to the remaining attributes in the relation.

The AL_NEST operator creates partitions based on the formation of equivalence classes to generate nested tables. Two tuples are equivalent if they have the same values for attributes, which are not being nested. AL_NEST operates on a row basis. Nesting can be done in two ways using a user interface (such as the GUI described above). A nested table can be dragged from the input to the output of a query transform and placed at the same or deeper level, or a nested schema can be created and columns from the input can be dragged and dropped into the newly created schema.

An explicit FROM clause might be needed where two views are coming into a query transform, and columns are selected from only one the views. The generated language is to select from both the views. For nesting of two input views containing only scalar columns, selecting from the both the views at the same level might not be desired. The following example illustrates this. Given a flat view V1 as:

CREATE VIEW ORDERS (ORDER_ID INT, PROD_ID INT, QTY INT, CID INT, CCITY VARCHAR(65))

CREATE VIEW VENDORS (PROD_ID INT, VNDR_ID VARCHAR(5), VNDR_CITY VARCHAR(65))

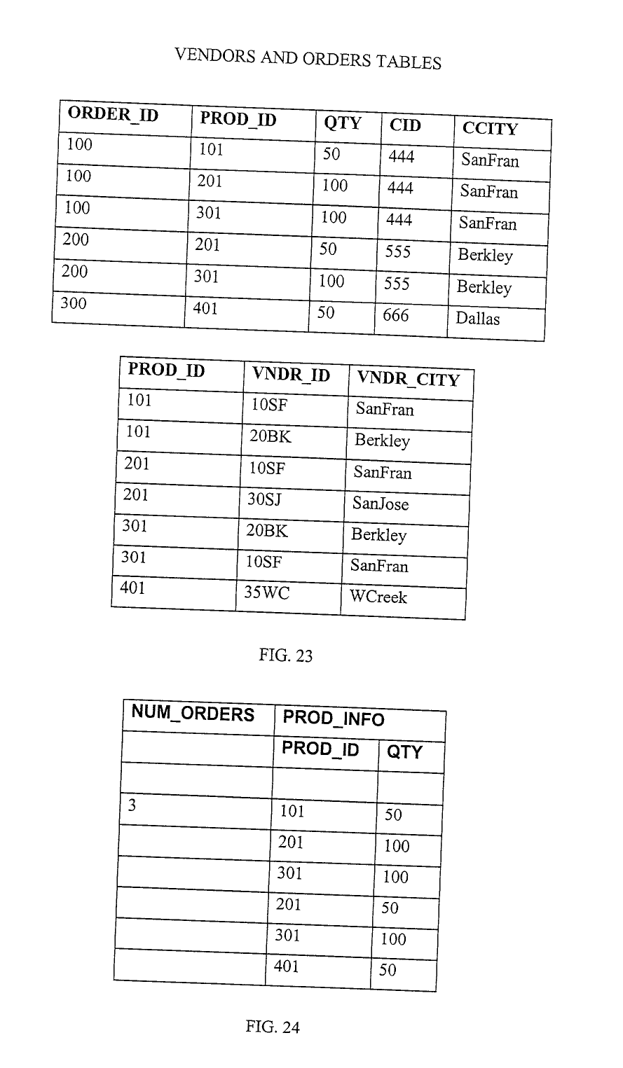

the table of flat relations shown in FIG. 23 results. A two level nesting to include vendor information using a JOIN can be demonstrated by the following example:

CREATE VIEW V2 (ORDER_ID INT,

PROD_INFO AL_NESTED_TABLE (PROD_ID INT,

QTY INT,

VENDOR_INFO
AL_NESTED_TABLE (

VNDR_ID CHAR(5),
VNDR_CITY CHAR(65)
)

),

CID,
CCITY
)

AS SELECT ORDER_ID,

AL_NEST (CREATE VIEW PROD_INFO (PROD_ID INT, QTY INT)

AS SELECT PROD_ID,

QTY,
AL_NEST (CREATE VIEW VENDOR_INFO

(VNDR_ID CHAR(5),
VNDR_CITY CHAR(65)) AS

SELECT VNDR_ID, VNDR_CITY
FROM VENDORS
WHERE VENDORS.PROD_ID = L1.PROD_ID

)

AS VENDOR_INFO

FROM ORDERS L1
WHERE L1.ORDER_ID = L0.ORDER_ID AND
L1.CID = L0.CID AND
L1.CCITY = L0.CCITY

)

AS PROD_INFO,
CID,
CCITY

FROM ORDERS L0

The explicit FROM clause prevents the usage of the VENDORS in the outermost select. This may produce a nested table as shown in FIG. 22, except with three rows with ORDER_ID equal to 100, two rows with ORDER_ID equal to 200 and one row with ORDER_ID 300, because AL_NEST operates on a row basis, which can produce duplicates.

The AL_NEST operator may be used to perform nesting on a set of rows also. If there is a GROUP BY, the set formed by the GROUP BY is used. If there are aggregate functions and a GROUP BY is specified, the set formed by the GROUP BY is used. If there are aggregate functions and a GROUP BY is not specified, then the default grouping is the entire table. All nested tables in the set operated by the AL_NEST may be merged.

Using AL_NEST_SET with an Aggregate Function

This operation may take in a view with nested tables and produce a single row, which has count of ORDER_ID's and the merge of all nested tables:

CREATE VIEW V2 (NUM_ORDERS INT,

PROD_INFO AL_NESTED_TABLE (PROD_ID INT,

QTY INT
)

)

AS SELECT COUNT(ORDER_ID),

AL_NEST_SET (CREATE VIEW PROD_INFO (PROD_ID INT,

QTY INT) AS
SELECT PROD_ID, QTY
FROM PROD_INFO
)
AS PROD_INFO,

FROM V1

Such a query might produce the table shown in FIG. 24. If the nested table(s) SELECT(S) have WHERE clauses, the nested table(s) might first be merged and the filters applied to the merged table(s).

AL_UNNEST

The AL_UNNEST operator transforms a relation into one that is less deeply nested by concatenating each tuple in the relation being unnested to the remaining attributes in the relation. To unnest the vendor information from the nested table in FIG. 22, the following ATL might be defined:

CREATE VIEW V2 (ORDER_ID INT,

PROD_INFO AL_NESTED_TABLE (PROD_ID INT,

QTY INT,
VNDR_ID CHAR(5)))

AS SELECT ORDER_ID,

AL_NEST (CREATE VIEW PROD_INFO (PROD_ID INT, QTY INT) AS

SELECT V1.PROD_INFO.PROD_ID,

V1.PROD_INFO.QTY,
AL_UNNEST (CREATE VIEW VDR_INFO

(VNDR_ID INT) AS

SELECT
V1.PROD_INFO.VENDOR_INFO.VNDR_ID

FROM V1.PROD_INFO.VENDOR_INFO)

FROM V1.PROD_INFO)

AS PROD_INFO

FROM V1

WHERE clauses can be applied in the SELECT for unnesting by drilling into the nested table which would produce a query transform, specifying the condition there, as shown in the following example:

CREATE VIEW V2 (VNDR_ID CHAR(5), VNDR_CITY CHAR(65))
AS SELECT DISTINCT AL_UNNEST (CREATE VIEW

UNEST1(VNDR_ID CHAR(5),
VNDR_CITY CHAR(65))

AS SELECT

AL_UNNEST (CREATE VIEW

UNEST2(VNDR_ID CHAR(5),

VNDR_CITY
CHAR (65))

AS SELECT VNDR_ID, VNDR_CITY

FROM VENDOR_INFO)

FROM PROD_INFO

)

FROM V1

Project

An example of a simple projection from one hierarchical structure to another would be:

CREATE VIEW V2 (

ORDER_ID INT,
PROD_INFO AL_NESTED_TABLE(PROD_ID INT, QTY INT)
)

AS SELECT ORDER_ID,

AL_NEST(CREATE VIEW PROD_INFO(PROD_ID INT, QTY INT)
AS SELECT V1.PROD_INFO.PROD_ID, V1.PROD_INFO.QTY

FROM V1.PROD_INFO)

AS PROD_INFO

FROM V1

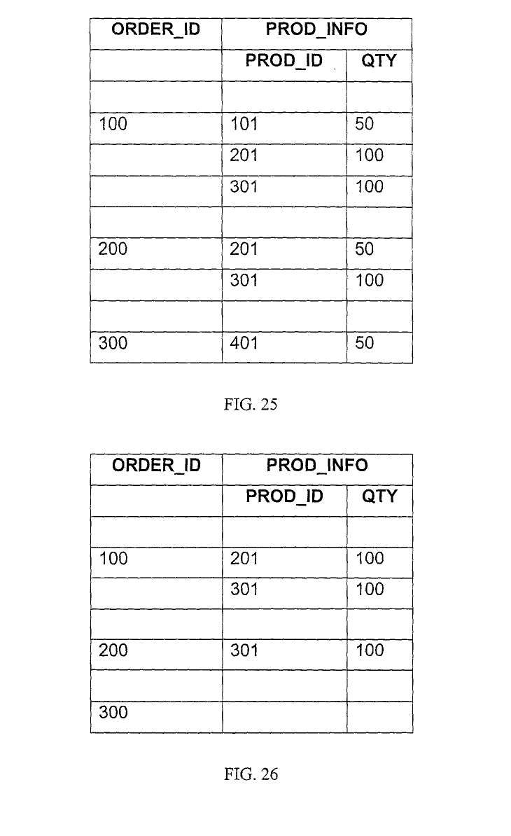

The qualifier V1.PROD_INFO in the nested relation is not really needed; the nested query could have been written using just PROD_INFO. The result might be the table shown in FIG. 25.

Select

Filter conditions can be applied at various levels. Consider the example of view V1 (FIG. 22) that has three levels of nesting. A filter on the nested relation PROD_INFO might be implemented as follows:

CREATE VIEW V3 (ORDER_ID INT,

PROD_INFO AL_NESTED_TABLE (PROD_ID INT, QTY INT)

)

AS SELECT

ORDER_ID,
AL_NEST (CREATE VIEW PROD_INFO(PROD_ID INT, QTY INT)
AS SELECT V1.PROD_INFO.PROD_ID,

V1.PROD_INFO.QTY

FROM V1.PROD_INFO
WHERE V1.PROD_INFO.QTY > 50)

AS PROD_INFO

FROM V1

This may select all the rows from V1, but for the nested table PROD_INFO, only those rows are chosen where the quantity ordered QTY is greater than 50, resulting in the table shown in FIG. 26.

Alternate Support For Filters In The WHERE Clause

For a nested table to be used in a WHERE clause sub-query, support within a WHERE clause should be available. If such support is not available, it can be overcome by using two stages and the ISEMPTY operator for nested tables. Nested tables can be used in a WHERE clause only with the ISEMPTY operator. The following example illustrates the use, selecting all the rows from V1 that have ORDER_ID greater than 100 and that have at least one product with a quantity ordered greater than 50.

CREATE VIEW V3 (ORDER_ID INT,

PROD_INFO AL_NESTED_TABLE(PROD_ID INT, QTY INT),
TEMP_PROD_INFO AL_NESTED_TABLE(PROD_ID INT, QTY

INT)

)

AS SELECT

ORDER_ID,
AL_NEST(CREATE VIEW PROD_INFO(PROD_ID INT, QTY INT)

AS SELECT V1.PROD_INFO.PROD_ID,

V1.PROD_INFO.QTY

FROM V1.PROD_INFO
)

AS PROD_INFO,
AL_NEST(CREATE VIEW PROD_INFO(PROD_ID INT, QTY INT)
AS SELECT V1.PROD_INFO.PROD_ID,

V1.PROD_INFO.QTY

FROM V1.PROD_INFO
WHERE V1.PROD_INFO.QTY > 50)

AS TEMP_PROD_INFO

FROM V1 WHERE V1.ORDER_ID > 100
CREATE VIEW V4 (ORDER_ID INT,

PROD_INFO AL_NESTED TABLE(PROD_ID INT, QTY INT)
)

AS SELECT

ORDER_ID,
AL_NEST(CREATE VIEW PROD_INFO(PROD_ID INT, QTY INT)
AS SELECT V1.PROD_INFO.PROD_ID,

V1.PROD_INFO.QTY

FROM V1.PROD_INFO
)

AS PROD_INFO

FROM V3 WHERE !ISEMPTY(TEMP_PROD_INFO)

Join

Nested relations can be joined with any other relations. An example is given below:

CREATE VIEW ORDERS (ORDERID INT, PRODUCTS

AL_NESTED_TABLE (PRODID INT, PRODNAME VARCHAR (10)));

CREATE VIEW VENDORS (PRODID INT, VENDORID INT,

VENDORNAME VARCHAR (10));

CREATE VIEW ORDERS_WITH_VENDORS (ORDERID INT,

PRODUCTS AL_NESTED_TABLE (PRODID INT,

PRODNAME VARCHAR (10),
VENDORID INT)

AS
SELECT ORDERID,

AL_NEST (CREATE VIEW PRODUCTS (PRODID INT,

PRODNAME VARCHAR(10),

VENDORID INT)

AS SELECT PRODID, PRODNAME, VENDORID

FROM PRODUCTS, VENDORS
WHERE PRODUCTS.PRODID = VENDORS.PRODID)

AS PRODUCTS

FROM ORDERS GROUP BY ORDERID

Nested Table Transform

A system transform is available that takes in a flat view and produces a singleton that has a N integer scalar column with a value 1, and a nested table containing the input view.

Tables as Parameters

Tables can be used as parameters for imported functions. Given a function get_orders with an input parameter customer_id and an output parameter orders:

CREATE FUNCTION get_orders (cust_id int,

orders AL_NESTED_TABLE(order_id int, . . . )
OUTPUT,
cust_info AL_NESTED_TABLE(cust_name, . . . )
OUTPUT);

Get orders for each customer by calling the orders function:

CREATE VIEW customer_orders (customer_id int,

orders AL_NESTED_TABLE (order_id

int, . . . ))

AS SELECT customer_id,

AL_NEST (get_orders (customer_id)::orders)
AS orders

FROM customers;

if the function has multiple tables as outputs, and all or some of them are required, then the function has to be invoked multiple times: once for each output.

```
CREATE VIEW customer_orders (customer_id int,
      cust_info AL_NESTED_TABLE(cust_name,..),
        orders AL_NESTED_TABLE (order_id
      int, ...))
AS SELECT customer_id,
    AL_NEST (get_orders (customer_id)::cust_info) AS
cust_info
    AL_NEST (get_orders (customer_id)::orders) AS orders
FROM customers;
```

As an optimization, the system could invoke the function only once and use those results for different instances within the query transform. For mapping a function returning table, a user would create a nested table column and map the nested table column to the function returning a table. The schema of the nested table may then be identical to the schema returned by the function. This is a concept of a “generated table”. The schema definition of generated table cannot be modified, and it should disappear when the function is removed from the mapping. It should be represented differently in the UI so that a user can distinguish between a generated table and a non-generated table.

Hierarchical File Reader

A hierarchical file reader reads data generated by data flows that have functions that return tables. There are two main alternatives: model the file reader as an XML file reader or model the file reader using a proprietary format to represent hierarchical data.

Effect of NRDM on System Transforms

System transforms such as Table_Comparison, Hierarchy_Flattening, etc. accept only rows with scalar columns.

Table Comparison: The output schema of the table comparison transform is a generated schema and is same as the schema of the table being compared against. This transform may silently ignore columns that are nested tables.

History Preserving: The output schema of the history preserving transform is same as the input schema, and this transform may preserve history only scalar columns and may act as pass through for columns that are nested tables.

Effective Date: The transform may act as pass through for columns that are nested tables.

Key Generation: The output schema of the key generation transform is same as the input schema, and this transform may act as pass through for columns that are nested tables.

Map Operation: The output schema of the map operation transform is same as the input schema, and this transform may not allow operations to be mapped for columns as nested tables and may act as pass through for them.

Hierarchy Flattening: Columns as nested tables cannot be a parent or child column of a hierarchy, but they can be dragged and dropped attribute columns and thus can appear in the output schema.

Pivot: The output schema of the hierarchy flattening transform is a generated schema and columns, as nested tables may be ignored.

A Case Study

A case study of a Sales Order IDoc using NRDM was performed. The IDoc was captured in a NRDM and perform transformations, to arrive at the same result as if the NRDM was not used, but with simplified specification of the transformations.

An IDoc is divided into a control record, data records and a status record. Each control record and status record has numerous fields. For our purpose of validating the NRDM, we treated control records and status records as single varchar columns. The ATL to represent a Sales Order (some of the columns associated with nested tables might be omitted in the listing) is:

CREATE VIEW V1 (

CONTROL_RECORD VARCHAR (100),
STATUS_RECORD VARCHAR (100),
E2CMCCO AL_NESTED_TABLE (

ZEITP VARCHAR (2), .. ,
E2CVBUK AL_NESTED_TABLE (

SUPKZ VARCHAR (1), ..,
E2CVBAK AL_NESTED_TABLE (

SUPKZ VARCHAR (1), ..,
E2CVBKO AL_NESTED_TABLE(

SUPKZ VARCHAR (1),

),
E2CVBPO AL_NESTED_TABLE (

SUPKZ VARCHAR

(1),

E2CVBAP AL_NESTED_TABLE (

SUPKZ VARCHAR (1),
E2CVBA2

AL_NESTED_TABLE(

SUPKZ

VARCHAR(1),

),
E2CVBUP

AL_NESTED_TABLE(

SUPKZ

VARCHAR(1),
),
E2CVBPF

AL_NESTED_TABLE(

SUPKZ

VARCHAR (1)
),
E2CVBKD

AL_NESTED_TABLE(

SUPKZ

VARCHAR (1),
),
E2CKONV

AL_NESTED_TABLE(

SUPKZ

VARCHAR (1),
),
E2CVBPA

AL_NESTED_TABLE(

SUPKZ

VARCHAR (1),
),
E2CVBFA

AL_NESTED_TABLE(

SUPKZ

VARCHAR (1),
),
E2CFPLT

AL_NESTED_TABLE(

SUPKZ

VARCHAR (1),
),
E2CVBEP

AL_NESTED_TABLE(

SUPKZ

VARCHAR (1),
),

), # E2CVBAP

), # E2CVBAK

), # E2CVBUK

) # E2CMCCO

# V1
The ATL corresponding to the population of the sales order fact table from
the above view may be (with some columns omitted for illustration purposes):

| | | |
|---|---|---|
| CREATE VIEW V2 ( | SO_NUM, | # VBAK.VBELN |
| | SOLD_TO, | # VBAK.KUNNR |
| | LINE ITEM ID, | # VBAP.POSNR |
| | CREATE_DATE, | # VBAP.ERDAT |
| | SHIP_TO, | # VBPA.KU.NNR |
| | DELIVERY_STATUS | # VBUP.LFGSA |
| | ) | |

AS SELECT AL_UNNEST

(SELECT AL_UNNEST

(SELECT AL_UNNEST

(SELECT VBELN, KUNNR,

AL_UNNEST (SELECT POSNR, ERDAT,

AL_UNNEST (SELECT KUNNR FROM

E2CVBPA

WHERE PARVW =

‘WE’),

AL_UNNEST (SELECT LFGSA FROM

E2CVBUP)

FROM E2CVBAP
)

FROM V1.E2CMCCO.E2CVBUK.E2CVBAK

FROM V1.E2CMCCO.E2CVBUK
)

FROM V1.E2CMCCO
)

FROM V1

What is claimed is:

1. An apparatus for processing data representable in a hierarchical form, the apparatus comprising:
an importer having inputs to receive a schema and a structured document from a data source, wherein the importer outputs a first nested relational data model (NRDM) data structure representing the structured document according to the received schema;
an transformation engine that is capable of transforming the first NRDM data structure output by the importer into a second NRDM data structure according to a declarative specification of a transform; and
an exporter having an input to receive the second NRDM data structure, wherein the exporter outputs a transformed hierarchical document in a data structure other than an NRDM data structure in a form suitable for a data target.

2. The apparatus of claim 1, further comprising means for converting relational data to an NRDM data structure by vertically partitioning a relation and nesting parts of the relational data as a nested table.

3. The apparatus of claim 1, further comprising means for converting nested relational data to relational data by unnesting the nested tables using a cross-product between a parent row and a child subtable.

4. The apparatus of claim 1, further comprising means for performing a grouping operation on a nested table that generates a resulting nested table containing a union of all the nested tables grouped by the operation.

5. The apparatus of claim 1, further comprising means for performing multi-step transformations, wherein an input to a transformation is results of a previous transformation, a data source, or both.

6. The apparatus of claim 1, wherein the transformation engine operates on rules that are applied to data independent of data format.

7. The apparatus of claim 1, wherein the exported is adapted to output one or more of an XML file, a relational table or a flat file.

8. A metadata mapper comprising:
an input for receiving a document description for hierarchical documents; and
an output for outputting an NRDM data structure representing the document description.

9. An apparatus for transforming data representable in a hierarchical form, the apparatus comprising:
an importer having inputs to receive a schema and a structured document from a data source, from a data transformer, or from both, wherein the importer outputs a first nested relational data model (NRDM) data structure representing the structured document according to the received schema;
an transformation engine that is capable of transforming the first NRDM data structure output by the importer into a second NRDM data structure according to a declarative specification of a transform; and
an exporter having an input to receive the second NRDM data structure, wherein the exporter outputs a transformed hierarchical document in a data structure other than an NRDM data structure in a form suitable for a data target.

10. A method for providing data to an application through a data platform in a computer system in response to request from the application, the method comprising:
accepting declarative rules for accessing the data from data sources and declarative rules for transforming the data into a format requested by the application;
mapping relational and non-relational data sources to an NRDM data structure;
interpreting a request;
retrieving data from the data sources;
transforming the data according to the declarative rules; and
returning the transformed data to the application.

11. The method of claim 10, wherein requests are processed as messages and request messages contain sufficient information to drive data extraction into a data-oriented interface.

12. The method of claim 10, wherein the requests are application programming interface function calls.

13. A method for updating a plurality of data targets from a message, comprising:
making an update request through a data-oriented interface;
specifying declarative rules for updating the data targets;
importing metadata that maps relational and non-relational data targets to NRDM data structures;
interpreting incoming update requests;
transforming the data according to the declarative rules; and
updating the data targets.

14. The method of claim 13, further comprising:
making an update request using an application; and
causing one of a response to be sent to the application, an update of data, or both.

15. The method of claim 13, further comprising a step of combining the update request with other data before updating the data targets.

16. A method of providing input to an application expecting one or more tables as parameters to an input message, the method comprising:
mapping data in a NRDM data structure to function parameters; and
making a function calls to the application using the NRDM mapped data structure.
